(19) United States
(12) Patent Application Publication
(10) Pub. No.: US 2003/0165334 A1
(43) Pub. Date: Sep. 4, 2003

(54) Camera with viewfinder

(76) Inventors: Arthur P. Becker, New York, NY (US); Benjamin A. Wells, Lincoln, MA (US)

Correspondence Address: FISH & RICHARDSON P.C., 45 ROCKEFELLER PLAZA, SUITE 2800, NEW YORK, NY, 10111, US

(21) Appl. No.: 10/377,171

(22) Filed: Feb. 27, 2003

Related U.S. Application Data
(60) Provisional application No. 60/361,186, filed on Mar. 1, 2002.
(60) Provisional application No. 60/390,836, filed on Jun. 20, 2002.

(51) Int. Cl. G03B 17/00

(52) U.S. Cl. 396/84

(57) ABSTRACT

Various cameras are disclosed in which indicia on a mask may be selectively viewable to a user depending on the mode in which the camera is operated. The indicia may include, for example, a framing target to facilitate framing of an image to be photographed, or other symbol(s) indicative of the mode in which the camera may be operated.

### CROSS-REFERENCE TO RELATED APPLICATIONS

This application claims priority from U.S. Provisional Application Serial No. 60/361,186, filed Mar. 1, 2002, and U.S. Provisional Application Serial No. 60/390,836, filed Jun. 20, 2002.

### BACKGROUND

The disclosure relates to photographic cameras with viewfinders.

Cameras are sometimes divided into various categories according to their viewing system. Such categories may include viewfinder cameras, single-lens reflex (SLR) cameras, twin-lens reflex cameras and view cameras.

A viewfinder refers to a viewing device on a camera used by the photographer to see the field of view taken in by the camera's lens and the portion of the view that will be recorded on film.

The viewing system in a viewfinder camera may be separate from the lens used in taking the picture. Some viewfinder cameras include a separate viewing lens to assist the photographer in viewing the scene that the main lens will capture.

Viewfinders may include a wide angle mode and telephoto mode. Telephoto mode may be used, for example, to photograph distant objects, whereas wide angle mode may be used to photograph close objects.

### SUMMARY

Various cameras are disclosed in which indicia on a mask may be selectively viewable to a user depending on the mode in which the camera is operated. The indicia may include, for example, a framing target to facilitate framing of an image to be photographed, or other symbol(s) indicative of the mode in which the camera may be operated.

For example, in one aspect, a camera includes a mask with indicia that correspond, respectively, to one or more modes in which the camera may be operated. The camera has a viewfinder which includes a rear lens through which a user can view an image to be photographed. The camera includes a first partially transmissive mirror in the main viewing path of the camera and a second mirror that together with the first mirror provides a Z-shaped optical path from the mask through the rear lens to the user's eye. The indicia on the mask can be made selectively viewable to the user through the rear lens depending on the mode in which the camera is operated.

In some implementations, the camera may including a movable cover disposed on a front part of the camera. The cover may have first and second positions. When the cover is in the first position, a first set of the indicia on the mask can be viewable to a user through the rear lens, whereas when the cover is in the second position, a second set of the indicia can be viewable to the user through the rear lens. In other implementations, when the cover is in the first position, it prevents ambient light from illuminating at least a portion of the mask to prevent at least some of the indicia from being viewable to the user through the rear lens. When the cover is in the second position, it allows ambient light to illuminate the mask to allow those indicia to be viewable to the user through the rear lens.

According to another aspect, a camera includes a front lens and a rear lens substantially parallel to the front lens. A first optical path can be formed from the front lens to the rear lens to allow a user to view an image to be photographed as the user looks through the rear lens. The camera includes a mirror disposed along the first optical path and tilted at an angle with respect to the front and rear lenses. The camera also includes a mask with indicia that correspond to one of a multiple modes in which the camera can be operated. The mask is positioned out of the first optical path. A light source is provided adjacent the mask. When the light source is activated, it illuminates the mask, and an optical image of the indicia may be viewed simultaneously with the image to be photographed.

The disclosed camera designs may provide improved illumination of viewfinder targets and other icons under varying ambient light conditions. The designs may be particularly useful in inexpensive, single-use cameras having a telephoto mode. However, the designs may be applied to other cameras as well.

Other features and advantages will be readily apparent from the following detailed description, the accompanying drawings and the claims.

### BRIEF DESCRIPTION OF THE DRAWINGS

FIG. 1 illustrates a viewfinder of a camera.

FIG. 2 illustrates a framing mask for the camera.

FIGS. 3 and 4 illustrate other viewfinders.

FIGS. 5A and 5B illustrate viewfinders with framing masks decoupled from the eyepiece.

FIG. 6 illustrates a viewfinder with multiple mirrors that form the optical path for the framing mask image.

FIG. 7 illustrates a framing mask and other indicia on a camera lens.

FIG. 8 illustrates a top view of a camera that includes a framing mask.

FIG. 9 illustrates a front view of the camera of FIG. 8 in a wide angle mode.

FIG. 10 illustrates a front view of the camera of FIG. 8 in a telephoto mode.

FIG. 11 illustrates an example of a framing mask for use in the camera of FIGS. 8-10.

FIGS. 12 and 13 show the different indicia that a viewer may see when the camera of FIG. 8 is in the wide angle or telephoto modes.

FIG. 14 illustrates an example of a second mask for use in the camera of FIGS. 8-10.

### DETAILED DESCRIPTION

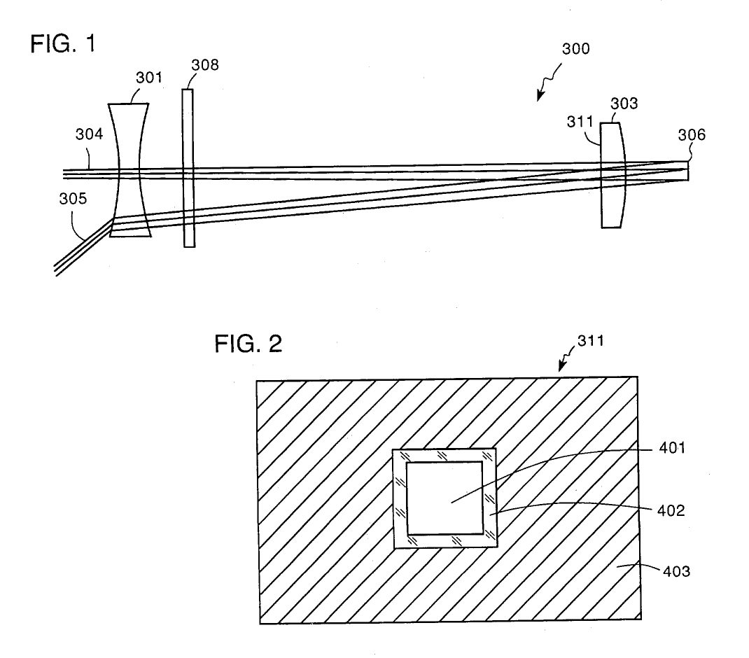

FIG. 1 illustrates a viewfinder 300 for a camera. The camera may be for example, a single-use camera having a wide angle mode as well as a telephoto mode. A front negative lens 301 is positioned on the objective side of the viewfinder 300. The front lens 301 may be, for example, about 20 mm in diameter, and may have an effective focal length of about −40 millimeters (mm). A planar mirror 308 is disposed near the front negative lens 301. The planar mirror 308 preferably has a larger diameter than the front negative lens 301. The planar mirror 308 is partially reflective and may have, for example, a reflection ratio of approximately 50%-70% so that approximately 50%-30% of the incident light can pass through the mirror. In one implementation, the planar mirror 308 has a reflection ratio of approximately 70%. The incident light that can pass through the planar mirror 308 should be sufficiently bright to enable a user to view a brightly lit scene.

A positive rear lens 303 is positioned on the opposite side of the planar mirror 308 as the front mirror 301. The lenses 301 and 303 may form a conventional Galilean telescope. In one particular implementation, the rear positive lens 303 can be, for example, about 12 mm in diameter, and can have an effective focal length of about +84 mm. The front lens 301 and the rear lens 303 may be, for example, plastic or glass. Details of the lenses 301, 303 may differ for other implementations. A pattern, for example a framing target 311, is attached to the front surface of the positive rear lens 303.

Ray bundles 304 and 305 extend from points on a distant object (not shown), through front lens 301, partially reflective mirror 308 and rear lens 303, to form an image of the distant object which may be viewed by a user's eye located at position 306. An image of the framing target 311 may simultaneously be viewed through rear lens 303. Light from an outside scene passes throught the front lens 301, through partially reflective mirror 308, and finally illuminates the target 311. Light reflected from the target 311 is redirected toward the rear lens by partially reflective planar mirror 308. Making the indicia reflective can make it easier for the user to see them. The focal length of the lens 303 may be chosen so that the target 311 appears in sharp focus when viewed by the user.

The distance between the front lens 301 and the rear lens 303 can be determined as a function of the camera's dimensions. For example, the power of the rear lens 303 may be set so that the image of the framing target 311 is in focus at infinity. In that case, the focal length of the rear lens 303 is approximately twice the spacing between the front lens 301 and the rear lens 303. The power of the front lens 301 may be set, for example, such that the negative Galilean telescope defined by the front lens 301 and rear lens 303 is focused at infinity. In that case, the focal length of the front lens 301 is approximately half the focal length of the rear lens 303. This implies that the power of the Galilean telescope is approximately 0.5×.

The reflectance of the planar mirror 308 should be high enough to provide good contrast of the reflective indicia of the framing mask. The view through the viewfinder can be made dim enough to signal the operator that bright light is needed. The front lens 301 may be cut to a rectangular size to provide rough framing for the image when the wide angle mode of the camera, as opposed to the telephoto mode, is selected. The size of the reflective framing indicia on the framing mask can be selected to provide framing guidance when the telephoto mode of the camera is selected.

In some implementations, the framing target 311 is formed by applying a sticker to the front surface of the rear lens 303, or alternatively, by applying a sticker to a surface of a plate which is separate from the rear lens 303. The plate may be disposed between the planar mirror 308 and the rear lens 303. If a sticker is used to create the framing indicia and masking, it is preferable to cut out the central portion because adhesives utilized in such applications may not be completely transparent and, therefore, images may appear fuzzy when viewed through such adhesives. The framing target 311 also can be applied by hot stamping.

Referring to FIG. 2, a framing target 311 is affixed to the front surface of rear lens 303. A transparent and centrally located hole 401 is surrounded by an area 402 of reflective silver mylar, which in turn is surrounded by a flat black area 403. The pattern can assist a user in framing a scene being viewed through the viewfinder 300.

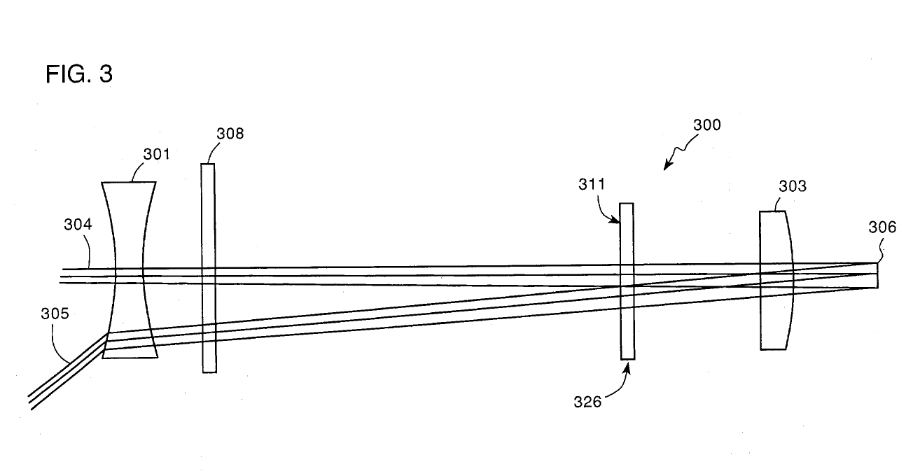

The viewfinder 300 of FIG. 3 includes a framing pattern 311 located on a transparent plate 326 disposed between the mirror 308 and the lens 303.

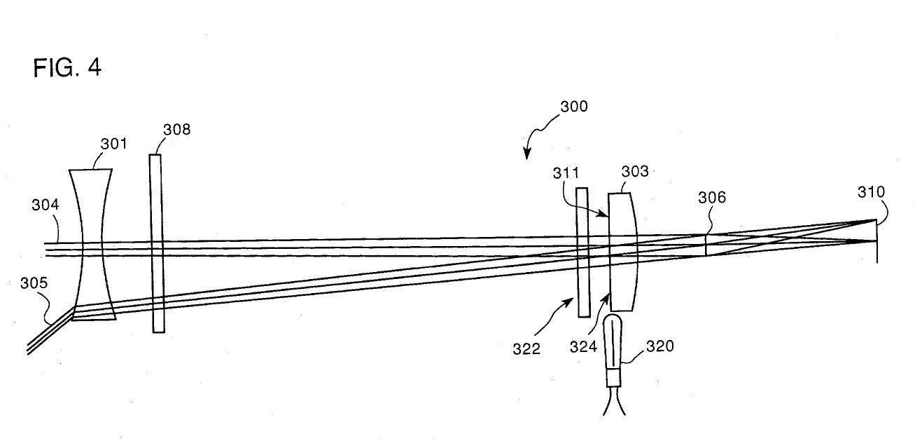

In other implementations, as shown in FIG. 4, a pattern 324 can be formed on lens 303 by etching or engraving one or more grooves in the surface of lens 303. These grooves may be, for example, V-shaped grooves, rectangular grooves, or any other conveniently shaped grooves. Use of grooves can help direct light toward the partially reflective mirror more efficiently. If external light is used as the illuminating source, V-shaped grooves may act as a mirror to reflect the light back. If an internal source is used, such as the light source 320, then triangular or rectangular may be more effective. The depth of the grooves can vary depending on the particular implementation. The internal light source 320 can be an artificial light source, such as a light emitting diode (LED) or a neon bulb. In some implementations, light is delivered from the light source 320 to illuminate the target through a light pipe such as an optical fiber. The light source 320 should be small and require relatively low amounts of energy to operate. The light source 320 may be mounted to or near lens 303 to illuminate the pattern 324.

Light from the source 320 is at least partially reflected by the pattern 324. This partially reflected light travels toward the planar mirror 308 and is again at least partially reflected. The reflected light travels back through the lens 303 and to the exit point 306 of the viewfinder 300. Directing the light toward the pattern 324 can make the pattern 324 highly visible to the eye 310 of a user under various ambient light conditions (e.g., very bright or very dark). The light source 320 preferably emits a colored light. The light source 320 can include one or more individual sources of light situated around the lens 303 to illuminate the pattern 324 from different angles.

An alternate method of providing the pattern 324 can include a plastic mold to on the surface of the lens 303. The mold can include transparent plastic material, but may be formed from other transparent materials as well. In such a case, the pattern 324 may be recessed or raised from the surface of lens 303, and light from the source 320 would be reflected from the raised pattern 324, thereby making the raised pattern 324 visible to the eye 310 of a user.

The planar mirror 308 can cause a substantially focused image of the pattern 324 to appear to the eye 310 of a user when the camera is operated in the telephoto mode. The pattern 324 can be made invisible to the eye 310 of a user by moving the planar mirror 308 out of the optical plane. For example, when the camera is operated in a mode other than the telephoto mode (e.g., a wide angle mode), the pattern can be brought out of focus, so that it is not visible at the viewing side of the viewfinder.

Parts of the pattern 324 may be made invisible to the eye 310 of a user by inserting a mask 322 between the rear lens 303 and the planar mirror 308. The mask 322 can include transparent areas as well as opaque areas. The opaque areas can be located on the mask 322 so that they at least partially prevent the transmission of light reflected from particular areas of the pattern 324. The mask 322 should be very thin and, when in place, is preferably located close to the lens 303.

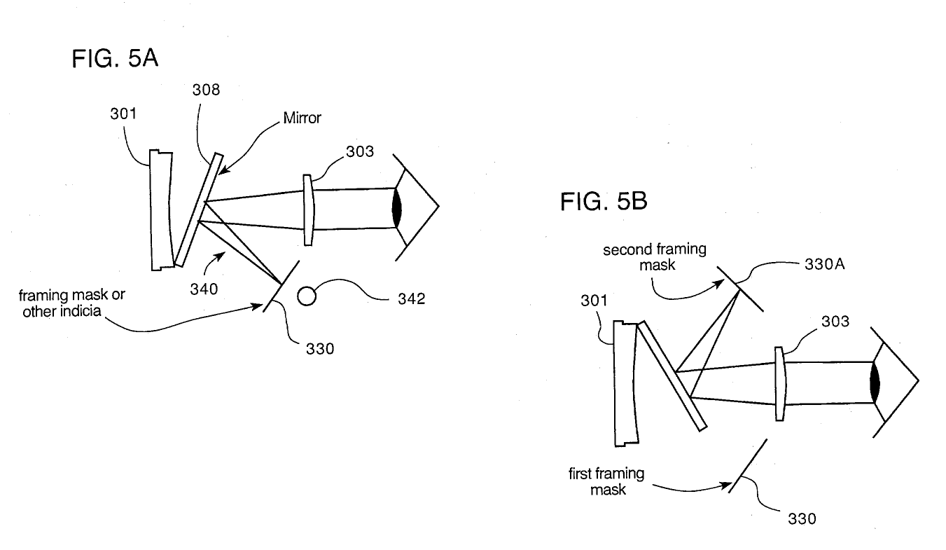

Referring to FIG. 5A, a camera with a viewfinder includes a framing target (mask) on a support material 330 that may be outside of the primary optical path between the lenses 301, 303. The planar mirror 308 may be tilted at an angle so that the optical axis of the framing target viewing path is not folded back on itself, but goes off in another direction as indicated, for example, by lines 340. The support material 330 may be formed of plastic, glass or other materials to allow the framing target to be lit from behind by a light source (not shown) such as an LED or small light bulb. Alternatively, the framing target on the support material 330 may be operated in a reflective mode in which light from an LED or other light source is shined on a reflective surface of the support material 330 so that the reflected image of the framing target appears to the user's eye.

The embodiment of FIG. 5A may allow a user to select one of several modes in which the framing target can selectively be made visible or invisible to the user's eye. For example, in one implementation, a light source such as a light emitting diode (LED) 342 may selectively be turned on to illuminate the framing target and make it visible to the user's eye. When the camera operates in a mode that does not require use of the framing target, the light source 342 would be turned off. Alternatively, in some implementations, the mirror may be slid out of position so that it leaves the optical path or rotated so that a different target 330A is viewed instead of target 330. A knob may be provided on the outer surface of the camera to allow the user to select the position of the mirror.

In another implementation, a second framing target may be provided on a second support surface 330A, as shown in FIG. 5B. When the mirror 308 is moved to its second position, as illustrated in FIG. 5B, the second framing target would be visible to the user's eye. The user may select one of the framing targets depending, for example, on the mode (e.g., telephoto, wide angle) in which the camera is operated.

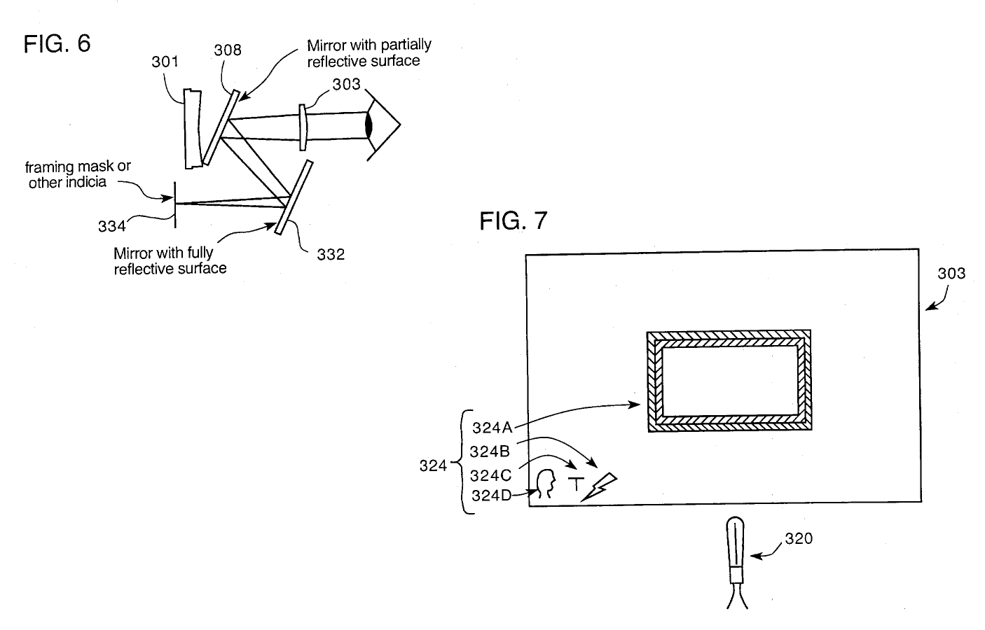

Referring to FIG. 6, a camera with a viewfinder includes two mirrors that form part of the optical path to provide an image of the framing target to the viewer's eye. In addition to the first mirror 308, a second mirror 332 is positioned to provide a folded (Z-shaped) optical path from the framing target surface 334 to the user's eye. The angles formed between the optical path and the mirrors 308, 332 may be ninety degrees or less. Preferably, the second mirror 332 has a fully reflective surface. Placing the framing target near the front of the camera as shown in FIG. 6 may allow the framing target to be illuminated by light from outside the camera, thereby avoiding the need for an LED or other illumination source inside the camera. Using light from outside the camera may allow a brighter framing target to be provided. By increasing the reflectivity of the mirror 308, the outside scene becomes dimmer, and the framing indicia becomes brighter. Furthermore, using the two mirror configuration can provide greater flexibility in the power of the viewfinder, which in some cases, may be increased to greater than 0.5×.

Although the foregoing implementations relate to providing a framing target, other indicia may be provided in the same ways in addition to or instead of the framing target.

As shown for example in FIG. 7, the front surface of rear lens 303 includes a pattern 324 that can be made visible to the eye of a user looking through the viewfinder. The illustrated pattern 324 includes a framing target 324A and icons 324B, 324C, and 324D. The framing target 324A is substantially rectangular, but it may be square, circular, or any other shape to assist a user in properly framing a photograph. The framing target 324A can be under-framed to provide some tolerance if the camera is slightly mis-aligned with respect to the scene to be photographed. The illustrated icons include a flashbulb charge indicator symbol 324B, a telephoto mode indicator symbol 324C, and a portrait mode indicator symbol 324D. Those icons can provide a user with information about the operation of the camera and various other conditions.

The pattern 324 can be formed on lens 303 by etching or engraving one or more grooves in the surface of lens 303. These grooves may be, for example, V-shaped grooves, rectangular grooves, or any other conveniently shaped grooves. The depth of the grooves can be varied. Alternatively, the pattern 324 can be molded onto the lens 303.

Techniques generally known in the art may be implemented to prevent light from undesirably scattering throughout different portions of the viewfinder. These techniques can include, for example, darkening portions of the rear lens 303 or installing baffles to direct the light to specific areas only.

One particular implementation includes a viewfinder that can be switched between a first mode that supports the taking of telephoto photographs and a second mode that supports the taking of photographs with a wider image. The viewfinder also can alert an operator of the need for brighter light in telephoto mode and can provide accurate framing marks in telephoto mode.

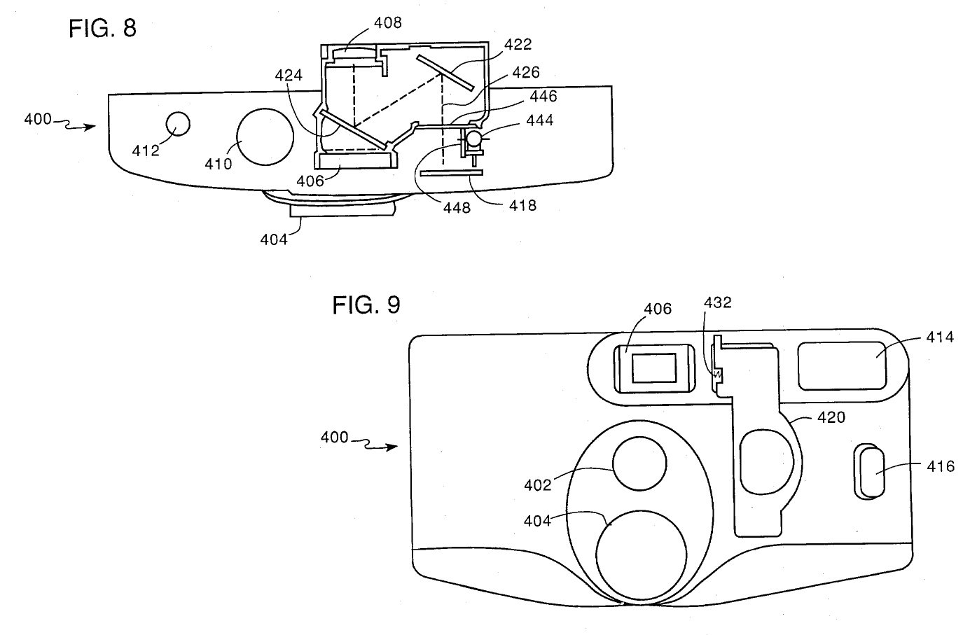

FIGS. 8-10 illustrate an example of a dual lens camera 400 that may be operated either in a wide angle mode or telephoto mode. The camera includes a short focus, or wide angle, lens 402 and a long focus, or telephoto, lens 404. The camera includes a viewfinder lens 406 and a viewfinder objective (rear) lens 408. The user presses the shutter release button 410 to take a photograph. An exposure counter 412 may keep track of the number of exposures remaining on the film or the number of exposures used. The camera also includes a flash 414 which may be activated by depressing a flash button 416.

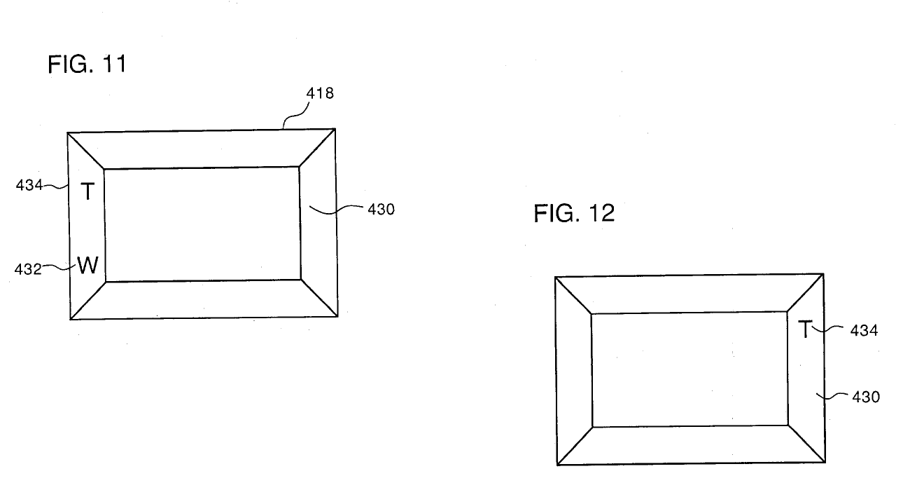

As shown in FIG. 8, a mask 418 is disposed near the front of the camera. An implementation of the mask 418 is shown in FIG. 11 and includes a framing target 430 for use in the telephoto mode as well as symbols 432, 434 that indicate to the user whether the camera is in the wide angle or telephoto mode, respectively. Portions of the mask, such as the symbols 432, 434 and the outline of the framing target, may be opaque. Other portions of the mask, such as the inner area of the framing target 430, may be semi-opaque to facilitate proper framing of the scene to be photographed. In general, the mask may include one or more indicia which can be made selectively viewable to the user through the lens 408 depending on the mode in which the camera is operated.

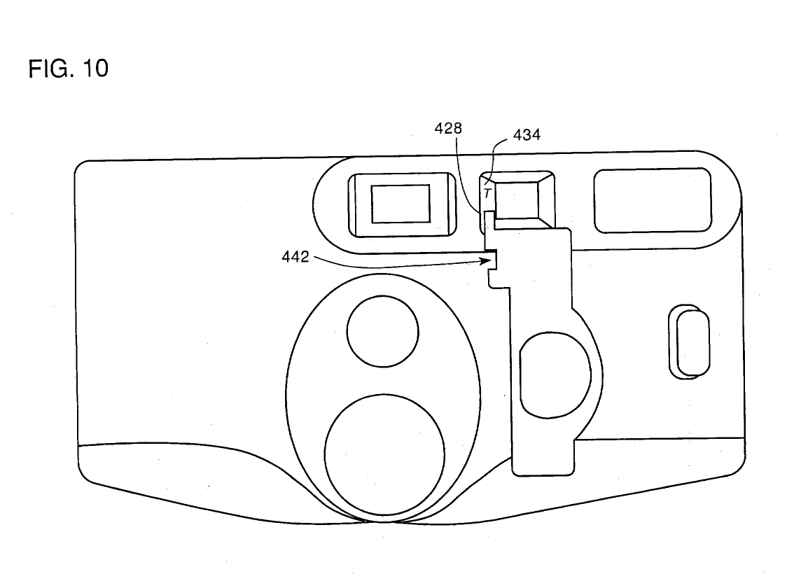

A movable cover 420 is positioned on the front of the camera. The user may slide the cover upwards so that it is in a first position (see FIG. 9) or downwards so that it is in a second position (see FIG. 10). Sliding the cover 420 to the lower position places the camera in the telephoto mode, whereas sliding the cover to the upper position places the camera in the wide angle mode. In the wide angle mode, light can pass directly through wide angle lens 402 to photosensitive material, such as film, in the camera. In the telephoto mode, a mirror (not shown) may be moved into position between the lens 402 and the film. The back of the mirror may be blackened to prevent light passing through the wide angle lens 404 from reaching the film. The front surface of the mirror completes an optical path from the lens 404 to the film using reflection from two mirrors.

For example, in one implementation, movement of the plate downward causes a mirror (not shown) to be positioned such that optical paths are provided from the telephoto lens to the viewer's eye and to the exposure aperture (not shown).

When the cover 420 is positioned in the telephoto mode as shown in FIG. 10, ambient light passes through the mask 418 such that the framing target 430 and telephoto mode symbol 434 (FIG. 11) may be viewed by the user through the viewfinder. The ambient light passes through the mask 418 and is reflected by mirrors 422, 424 (FIG. 8) to reach the viewer's eye. The optical path of the light passing through the mask 418 is indicated by the dashed line 426 in FIG. 8.

In the illustrated implementation, the cover 420 includes an extension 428 near its upper end. When the cover is positioned for the telephoto mode (FIG. 10), the extension 428 blocks the ambient light from passing through the portion of the mask 418 that includes the wide angle mode symbol 434. Thus, the user will see the framing target 430 and the telephoto mode symbol 434, but not the wide angle mode symbol 434 as illustrated in FIG. 12.

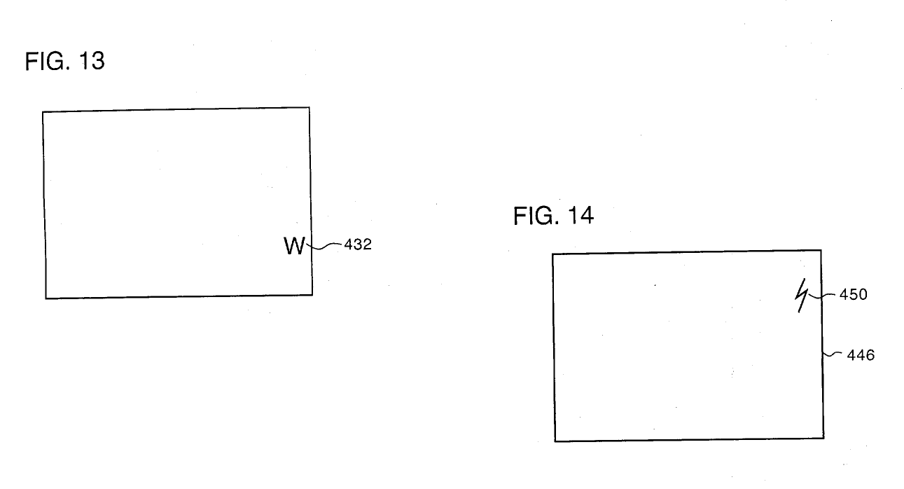

On the other hand, sliding the cover 420 upwards places the camera in the wide angle mode (FIG. 9). When the cover 420 is positioned for the wide angle mode as shown in FIG. 9, most of the mask 418 is blocked by the upper portion of the cover. The cover 420, however, includes a cutout area 442 that allows the ambient light to pass through the mask so that the wide angle mode symbol 432 is illuminated and is visible to the user through the viewfinder as illustrated in FIG. 13. The cover 418 prevents the ambient light from illuminating the target frame 430 (other than in the immediate area of the wide angle mode symbol 432) and the telephoto mode symbol 434.

The particular shape of the cover 420 need not be limited to the particular shape illustrated in FIGS. 9 and 10. In general, however, the cover should be shaped so that when the camera is to be operated in a first mode, the cover is in a first position so that a first set of indicia on the mask 418 is made visible to the user through the viewfinder, and when the camera is operated in a second mode, the cover is in a second position so that a second set of indicia on the mask is made visible to the user.

As mentioned above, the camera 400 of FIG. 8 also includes a flash 414 which may be activated by depressing a flash button 416, for example, when the camera is operated in the wide angle mode. In the illustrated implementation, depressing the button 416 also causes a light emitting diode (LED) 444 or other light source to be activated so as to illuminate a portion of a second mask 446. The illuminated portion of the second mask 446 may include, for example, a flash icon 450 (see FIG. 14) to indicate that the flashbulb is charged and ready for use. A wall 448 is provided adjacent the LED 444 so that the flash icon 450 is visible to the user only while the LED is activated.

Viewfinders incorporating the techniques described above can provide relatively inexpensive improvements. The techniques may be implemented using readily available components and can identify for the user the mode in which the camera is being operated.

In some implementations, one or more of the following advantages may be present. A sharply focused framing target can be visible through a camera's viewfinder. This effect can be achieved through a relatively simple and relatively inexpensive arrangement of components in the viewfinder.

The techniques can provide improved illumination of viewfinder targets and other icons under varying ambient light conditions. These techniques may be particularly useful in inexpensive, single-use cameras having a telephoto mode. However, the techniques of etching, engraving, or molding a pattern on a lens and illuminating that pattern with a light source in the camera can be applied to any camera that uses targets, icons, or other patterns.

Other implementations are within the scope of the following claims.

What is claimed is:

1. A camera comprising:
a viewfinder including a rear lens through which a user can view an image to be photographed;
a mask including indicia that correspond, respectively, to one or more modes in which the camera may be operated; and
a first partially transmissive mirror in a primary viewing path and a second mirror that together with the first mirror provides a Z-shaped optical path from the mask through the rear lens, wherein indicia on the mask can be made selectively viewable to the user through the rear lens depending on the mode in which the camera is operated.

2. The camera of claim 1 including a short focus lens and a long focus lens either one of which can be selected for forming an image on a photosensitive material in the camera.

3. The camera of claim 1 including a cover disposed on a front part of the camera, the cover having first and second positions, wherein when the cover is in the first position, a first set of the indicia can be viewable to a user through the rear lens, and wherein when the cover is in the second position, a second set of the indicia can be viewable to the user through the rear lens.

4. The camera of claim 3 wherein the cover is slidable between the first and second positions.

5. The camera of claim 1 including a cover disposed on a front part of the camera, the cover having first and second positions, wherein when the cover is in the first position the cover prevents ambient light from illuminating at least a portion of the mask to prevent at least some of the indicia from being viewable to the user through the rear lens, and wherein when the cover is in the second position, the cover allows ambient light to illuminate at least said portion of the mask to allow said at least some indicia to be viewable to the user through the rear lens.

6. The camera of claim 1 wherein the first and second mirrors are substantially parallel to one another.

7. The camera of claim 1 wherein the indicia include symbols representing, respectively, a telephoto mode and a wide angle mode.

8. The camera of claim 1 wherein the indicia include a framing target for use in a telephoto mode.

9. The camera of claim 1 including:
a flash;
a second mask including a flash indicator symbol, the second mask disposed along the optical path;
a light source positioned adjacent the second mask;
a button to activate the flash and the light source, wherein when said light source is activated, it illuminates a portion of the second mask that includes the flash indicator symbol to allow the user to view the flash indicator symbol through the rear lens.

10. The camera of claim 9 wherein the light source includes a light emitting diode.

11. The camera of claim 9 wherein the first and second masks are parallel to one another.

12. The camera of claim 3 including:
a flash;
a second mask including a flash indicator symbol, the second mask disposed along the optical path;
a light source positioned adjacent the second mask; and
a button to activate the flash and the light source, wherein when said light source is activated, it illuminates a portion of the second mask that includes the flash indicator symbol to allow the user to view the flash indicator symbol through the rear lens.

13. A camera comprising:
a front lens;
a rear lens substantially parallel to the front lens, wherein a first optical path can be formed from the front lens to the rear lens to allow a user to view an image to be photographed as the user looks through the rear lens;
a mirror disposed along said first optical path and tilted at an angle with respect to the front and rear lenses;
a first mask including indicia that correspond to one of a plurality of modes in which the camera can be operated, the first mask positioned out of the first optical path;
a light source adjacent the first mask,
wherein when said light source is activated, it illuminates the first mask and an optical image of the indicia is reflected by the mirror to the rear lens to enable the user to view the indicia simultaneously with the image to be photographed.

14. The camera of claim 13 wherein the indicia include a framing target.

15. The camera of claim 13 wherin the indicia identify a mode in which the camera is being operated.

16. The camera of claim 13 wherein the light source includes a light emitting diode.

17. The camera of claim 13 comprising:
a second mask including indicia that correspond to a second mode of operation, the second mask positioned on an opposite side of the first optical path from the first mask,
said mirror being selectively rotatable between first and second positions, wherein in said first position, an optical image of the indicia on the first mask is reflected by the mirror to the rear lens, and in said second position, an optical image of the indicia on the second mask is reflected by the mirror to the rear lens to enable the user to view the indicia of a particular one of the masks simultaneously with the image to be photographed.

18. The camera of claim 17 including a knob coupled to the mirror and extending to an exterior of the camera to allow the user to select the position of the mirror.

19. The camera of claim 13 wherein the light source is positioned behind the first mask.

20. The camera of claim 13 wherein the light source is positioned in front of the first mask.

21. The camera of claim 13 wherein the indicia are etched into the first mask.

22. The camera of claim 13 wherein the indicia are molded to the first mask.

23. The camera of claim 13 wherein the mirror is partially reflective.
